(19) United States
(12) Patent Application Publication
(10) Pub. No.: US 2005/0127130 A1
(43) Pub. Date: Jun. 16, 2005

(54) Frame tool and fastener

(76) Inventor: Jan Toczycki, Chicago, IL (US)

Correspondence Address: LISA M. SOLTIS;Illinois Tool Works, Inc., 3600 W. Lake Avenue, Glenview, IL, 60025, US

(21) Appl. No.: 10/733,615

(22) Filed: Dec. 11, 2003

(51) Int. Cl. B25C 7/00

(52) U.S. Cl. 227/148

(57) ABSTRACT

A pin driver usable with a frame tool for driving pins into a frame element having a reciprocating driver blade moveable between a retracted position and an extended position, a guide shoe associated with the driver blade for guiding the pin from a ready position to a driven position, and a hammer arm assembly mounted in operational relationship to the guide shoe configured to strike and bend the pin upon reaching the driven position.

### BACKGROUND OF THE INVENTION

This invention relates to tools used for assembling picture frames, and more particularly to such a tool which drives small nails, tabs or pins into a picture frame for holding the glass, the picture, and a backing in place.

Pin driver devices are well known in the art and typically use a pneumatic force to drive a nail or a pin (a planar pointed fastener) straight into a wooden frame portion of a picture frame to hold the glass, picture and backing into place. A disadvantage of this type of tool is that the nails or pins often provide insufficient holding power and additional clamping is needed. This additional clamping is generally achieved by bending the driven pins into the backing, an operation which typically requires an additional step.

Therefore, it is desired to have a device that combines a driving mechanism with a bending apparatus to both drive a pin into the wooden frame and subsequently bend it for additional clamping. Prior attempts to solve this problem employ a dual pneumatic piston assembly that separately drives a driver blade with one pneumatic piston for driving the pin and subsequently bends the pin with a separate mechanism using a second pneumatic piston. This operation is mechanically burdensome and, among other things, requires an extra connection for the second air piston. Operators of such frame tools favor an inexpensive and durable product that is simple to maintain. The above-identified combined two-step mechanism for driving and bending a pin has resulted in bulkier and more complicated devices.

Another design factor of frame pin drivers is that the pin driving mechanism be removable from the tool structure for maintenance purposes. Still another design factor is that the pin driver assembly be interchangeable with an assembly which does not bend the fastener.

Thus, there is a need for a frame tool capable of bending a pin when in the driven position that is mechanically inexpensive and is convenient to use. Furthermore, there is a need for such a device where the driving mechanism is easily removed for maintenance or interchangeable assembly purposes.

### BRIEF SUMMARY OF THE INVENTION

The above-identified needs are addressed by the present frame tool with a pin driver for driving pins into a frame element. One feature of the present tool is a hammer arm assembly that is actuated when the driver blade moves from a retracted position to an extended position so that the pin is driven into a frame element, then bent for additional clamping. In the preferred embodiment, the hammer arm assembly is pivotally actuated by the driver blade. A guide shoe is also included in the present pin driver to guide the pins from a ready position to a driven position and is removable from the tool to allow access to the hammer arm assembly. Furthermore, a biasing force is exerted on the hammer arm assembly toward a first position such that after bending a pin, the hammer arm assembly is positioned to be ready for a next pin. An optional feature of the present pin driver is a bumper pad that is configured to absorb impact energy generated by the hammer arm assembly striking the pin for protecting the guide shoe and/or the hammer arm assembly.

More specifically, a pin driver usable with a frame tool is provided that includes a reciprocating driver blade moveable between a retracted position and an extended position. A guide shoe is associated with the driver blade for guiding the pin from a ready position to a driven position. A hammer arm assembly is also mounted in an operational relationship to the guide shoe and is configured to strike and bend the pin upon reaching the driven position.

In an additional embodiment, a frame tool with a pin driver for driving pins into a frame element includes a housing. The frame tool further includes a reciprocating driver blade moveable relative to the housing between a retracted position and an extended position. A hammer arm assembly is mounted in operational relationship to the guide shoe and is configured to strike and bend the pin upon reaching the driven position. The driver blade is configured to be pivotally associated with the hammer arm assembly such that the movement of the driver blade from the retracted position to the extended position causes the hammer arm assembly to move from a first position to a second position at which the pin is bent.

### BRIEF DESCRIPTION OF THE DRAWINGS

FIG. 1 is a fragmentary side elevational view of a tool suitable for incorporating the present invention;

FIG. 2 is a fragmentary front view of the tool shown in FIG. 1; and

FIG. 3 is a cross section taken along the line of 3-3 of FIG. 2 and in the direction generally indicated.

### DETAILED DESCRIPTION OF THE INVENTION

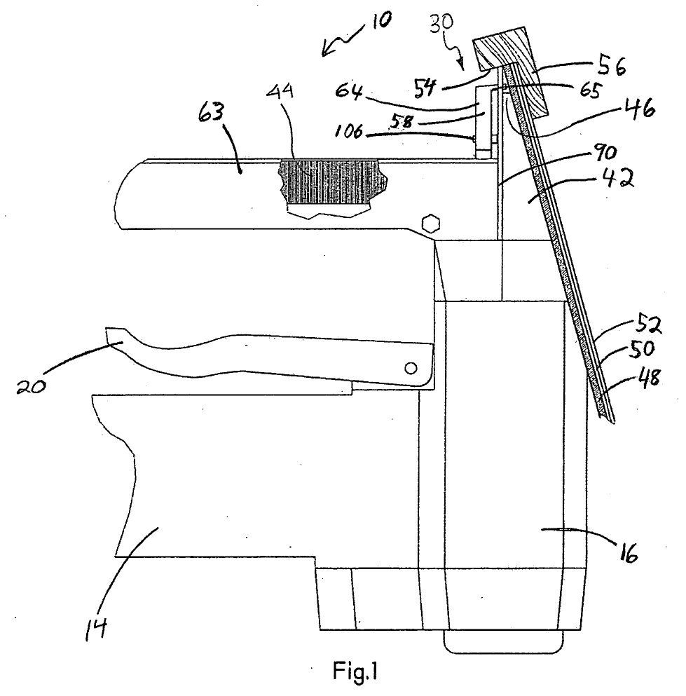

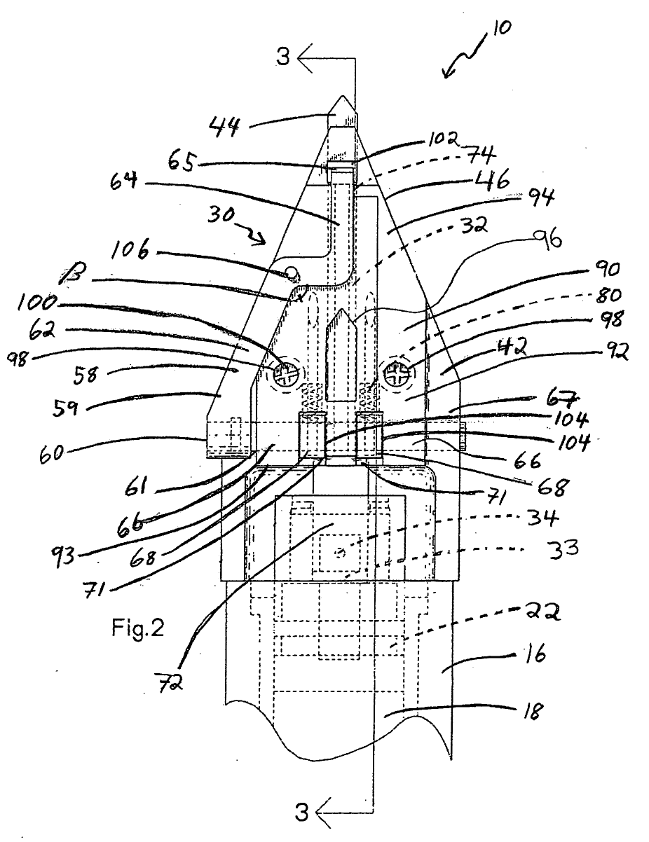

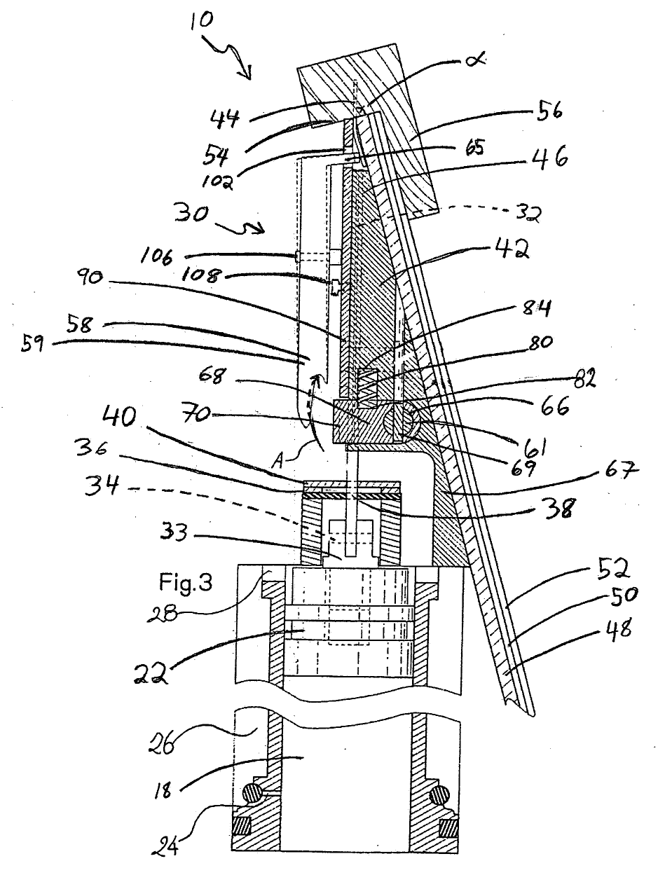

Referring now to FIGS. 1, 2 and 3, a frame tool for driving pins into a frame element is generally designated 10. Included on the preferably pneumatic frame tool 10 is an air intake connection (not shown) that connects to a gas or supply air line (not shown). Electronic or combustion powered tools are also contemplated. In the preferred embodiment, a handle 14 connects a housing 16 for enclosing a cylinder 18 as shown in FIG. 3 to the air intake connection. Compressed air from the gas supply is released into the cylinder 18 by a trigger mechanism 20. As known in the art, the cylinder 18 houses a pneumatic piston 22 that moves down the cylinder to an extended position shown in FIGS. 2 and 3 when the compressed air enters the cylinder 18. A check valve 24 allows air to flow into an outer chamber 26 for eventual reentry into the cylinder 18 through ports 28 for returning the piston to the start or ready position.

Referring now to FIGS. 2 and 3, a pin driver, generally designated 30 and usable with the frame tool 10, includes a reciprocating driver blade 32 moveable to the extended position. The driver blade 32 is attached to the pneumatic piston 22 for common movement, preferably by a clevis screw 33. In the preferred embodiment, the driver blade 32 is secured to the clevis screw 33 by at least one driver blade fastening pin 34. The cylinder 18 further includes a driver blade seal 36 configured to prevent air from escaping from the housing 16 past the cylinder. The driver blade seal 36 is preferably made of resilient material such as rubber or the equivalent and contains a slit 38 through a middle portion for slidingly allowing the driver blade 32 to pass while preventing the escape of air from the cylinder 18. A preferably annular seal spacer 40 is provided for supporting the driver blade seal 36 and is preferably made of metal or equivalent material to provide the required rigidity.

Now referring to FIGS. 1, 2 and 3, a guide shoe 42 is associated with the driver blade 32 for guiding a pin 44 to a driven position (FIGS. 2 and 3). The guide shoe 42 is preferably configured to be tapered towards a tip 46 (when viewed from the front (FIG. 2)) such that a location of the pin 44 in the driven position is generally predeterminable while the pin is ready to be driven. It is also preferred that the guide shoe 42 is wedge-shaped when viewed from the side (FIGS. 1 and 3) to facilitate insertion and driving of the pin 44 into the frame at an acute angle ∝. It is desirable that the pin 44, upon being driven, exerts a clamping force against a backing 48, a picture 50, and a glass 52 as shown in FIGS. 1 and 3 to retain these components against a base 54 of a preferably wood frame 56. It is contemplated, however, that the pin driver 30 is usable for frames made of other materials as well as other objects besides frames.

The pin driver 30 further includes a hammer arm assembly 58 mounted in operational relationship to the guide shoe 42 and configured to strike and bend the pin 44 upon reaching the driven position. The hammer arm assembly 58 is provided with a hammer arm 59 made of metal or equivalent material, and is preferably attached to a shaft end 60 of a shaft 61 mounted on the guide shoe 42 in transverse relationship to the driver blade 32.

The driver blade 32 is configured to be associated with the hammer arm assembly 58 such that the movement of the driver blade to the extended position causes the hammer arm assembly to pivotally move from a first or retracted position (shown in phantom in FIG. 3) to a second or impact position at which a portion of the pin 44 projecting above the base 54 is bent at an angle against the backing 48 (FIG. 3). The hammer arm 59 extends generally parallel to the driver blade 32 when viewed from the side (FIG. 3). An elongated portion 62 of the arm 59 is preferably configured to have a taper generally corresponding to the tapered guide shoe tip 46. In the preferred embodiment, the elongated portion 62 slants to an obtuse angle β (FIG. 2) located below a pin magazine 63 (FIG. 1). The obtuse angle β is configured to position a lower segment 64 of the elongated portion 62 in alignment with the driver blade 32.

The lower segment 64 of the arm 59 is provided with, a striking tip 65 that extends outward towards the pin 44 in the driven position. It is preferred that the striking tip 65 resides at an approximate 95 degree angle from the lower segment 64, however, any angle within the general 90 degree position that is capable of bending the pin is also contemplated. It is also preferred that the striking tip 65 be a metal extension of the hammer arm 59, however, other striking tips such as threaded fasteners and extension attachments are also contemplated.

Now referring to FIGS. 2 and 3, the shaft 61 is associated with the guide shoe 42 and is configured for compelling a pivoting action of the hammer arm assembly 58. In the preferred embodiment, the shaft 61 is cylindrical and the guide shoe 42 is provided with pivot eyelets 66 configured to rotatably receive the shaft. The pivot eyelets 66 are linearly spaced apart and are positioned on an upper portion 67 of the guide shoe 42 opposite from the tip 46. At least one blade striker arm 68 is coupled to the shaft 61 by a fastening pin 69 (FIG. 3) or other known fastening techniques so that a free end 70 of the striker arm 68 projects generally normally to the direction of travel of the driver blade 32.

Now referring to FIG. 2, the driver blade 32, which reciprocates within a slot in the guide shoe 42, has at least one shoulder 71 located closer to a rear end 72 than to a tip end 74. It is preferred that the at least one shoulder 71 is represented by a protrusion of the driver blade 32, resulting in the tip end being narrower than the rear end 72. Each shoulder 71 is associated with a corresponding at least one blade striker arm 68 such that the shoulder abuts the corresponding blade striker arm when the driver blade 32 moves to the extended position. In the preferred embodiment, two blade striker arms 68 are provided upon the shaft 61, one on each side of the driver blade 32.

The blade striker arms 68 move in an arc A (FIG. 3) caused by the driver blade 32 and have a movement ratio with the hammer arm assembly 58 of approximately 1:5 such that a 1 millimeter displacement of the free end 70 of the at least one blade striker arms result in a general 5 millimeter displacement of the lower segment 64 of the hammer arm assembly. It is also preferred that the movement of the hammer arm 59 due to the driver blade 32 striking the blade striker arms is approximately 0.060 inches between the first and second positions (FIG. 3). It is contemplated that the amount of displacement may vary to suit the application.

Referring now to FIG. 3, the pin driver 30 is also configured for exerting a biasing force on the hammer arm assembly 58 to urge the hammer arm assembly to the first position. It is preferred that at least one spring 80 is provided for exerting the biasing force. One end of the spring 80 is positioned in a recess 82 on the striker arm 68 and an opposite end of the spring is positioned in a guide shoe recess 84 in the guide shoe 42. In this construction, the spring 80 will force the hammer arm assembly 58 to rotate back to the first position after bending the pin 44. In the preferred embodiment, one spring 80 is provided for each of the preferably two blade striker arms 68.

Referring now to FIGS. 1 and 2, the pin magazine 63 positioned on the frame tool 10 is configured to feed pins 44 to the pin driver 30. A guide plate 90 is positioned between the guide shoe 42 and the pin magazine 63. The guide plate 90 is generally flat and contains a broadened portion 92 situated on a piston side 93 and a guide plate tip 94 tapered to conform with the guide shoe 42. In the preferred embodiment, the guide plate 90 is also configured to have a pin receiving hole 96 on the broadened portion 92 of the guide plate 90 such that pins 44 may be fed from the magazine 63 into the ready position for impact by the driver blade 32. Preferably, edge margins of the hole 96 are chamfered to facilitate pin guiding.

It is also preferred that the guide plate 90 is provided with at least two screw holes 98 located on adjacent sides of the pin receiving hole 96. The guide plate 90 is secured by fasteners 100 such as screws passing through the holes 98 and fastened to the frame tool 10. The fasteners 100 are configured to be removable such that the guide shoe 42, the guide plate 90, and the rest of the pin driven 30 are detachable from the frame tool 10. Removing the guide shoe 42 from the frame tool 10 provides the user with visual and physical access to the driver blade 32 and the hammer arm assembly 58 for maintenance purposes of the pin driver 30. Such removal of the pin driver 30 allows the attachment to the tool of an alternative assembly which does not bend the fastener.

Additionally, the guide plate 90 is constructed and arranged such that the striking tip 65 of the hammer arm 59 strikes the pin 44 upon reaching the driven position. The guide plate 90 is provided with an opening 102 disposed to allow the striking tip 65 to strike the pin 44, however, other configurations of guide plate are contemplated to allow the same striking action. It is preferred that the opening 102 be positioned near the guide plate tip 94 such that the pin 44 is bent when in the driven position. The guide plate 90 is also configured to allow rotation by the blade striker arms 68. It is preferred that a striker arm notch 104 is provided for each blade striker arm 68 on the side of the guide plate 90 nearest to the cylinder 18. Each striker arm notch 104 is preferably of sufficient size to accommodate movement of that the blade striker arm 68. It is also preferred that the guide plate 90 is made of a steel alloy or other durable material to resist damage from extended fastener driving operation.

Referring now to FIGS. 1, 2, and 3, at least one bumper pad 106 is provided for absorbing impact energy generated by the hammer arm assembly 58 striking the pin 44. The bumper pad 106 is preferably made of a resilient material such as rubber and is designed to protect the guide plate 90 and the hammer arm 59 from damaging each other. In the preferred embodiment, the bumper pad 106 is located on the guide plate 90 such that the bumper pad contacts the hammer arm 59 when the hammer arm assembly 58 reaches the second position. In a second embodiment as shown in FIG. 3, at least one bumper pad 108 is located on the hammer arm assembly 58 such that the bumper pad contacts the guide plate 90 when the hammer arm assembly reaches the second position.

Thus, it will be seen that the frame tool 10 for driving pins into a frame element makes it possible to mechanically drive and bend a pin using a single pneumatic device. The present pin driver 30 is durable, relatively inexpensive and is removable from the frame tool 10 for maintenance purposes.

While a particular embodiment of the present frame tool has been described herein, it will be appreciated by those skilled in the art that changes and modifications may be made thereto without departing from the invention in its broader aspects and as set forth in the following claims.

1. A pin driver usable with a frame tool for driving pins into a frame element, comprising:
a reciprocating driver blade moveable between a retracted position and an extended position;
a guide shoe associated with said driver blade for guiding the pin from a ready position to a driven position; and
a hammer arm assembly mounted in operational relationship to said guide shoe and configured to strike and bend the pin upon reaching the driven position.

2. The pin driver of claim 1 wherein said driver blade is configured to be associated with said hammer arm assembly such that the movement of said driver blade from said retracted position to said extended position causes said hammer arm assembly to pivotally move from a first position to a second position at which the pin is bent.

3. The pin driver of claim 2 further including a shaft associated with said guide shoe.

4. The pin driver of claim 3 wherein said guide shoe further includes pivot eyelets configured to rotatably receive said shaft.

5. The pin driver of claim 3 wherein said shaft is configured for compelling a pivoting action of said hammer arm assembly upon impact by said driver blade.

6. The pin driver of claim 5 further including at least one blade striker arm coupled to said shaft.

7. The pin driver of claim 6 wherein said driver blade has at least one shoulder that is associated with a corresponding said at least one blade striker arm such that said shoulder abuts said blade striker arm when said driver blade moves from said retracted position to said extended position.

8. The pin driver of claim 2 further configured for exerting a biasing force on said hammer arm assembly to said first position.

9. The pin driver of claim 8 further including at least one spring for exerting said biasing force.

10. The pin driver of claim 9 wherein one end of said at least one spring is positioned on said blade striker arm and another end of said at least one spring is positioned on said guide shoe.

11. The pin driver of claim 1 further including a guide plate constructed and arranged such that by said hammer arm assembly strikes the pin upon reaching said driven position.

12. The pin driver of claim 11 further including at least one bumper pad configured for absorbing impact energy generated by said hammer arm assembly striking the pin.

13. The pin driver of claim 12 wherein said at least one bumper pad is located on said guide plate such that said bumper pad contacts said hammer arm assembly when said hammer arm assembly reaches said second position.

14. The pin driver of claim 12 wherein said bumper pad is located on said hammer arm assembly such that said bumper pad contacts said guide plate when said hammer arm assembly reaches said second position.

15. The pin driver of claim 11 wherein said guide plate is made of a steel alloy.

16. A frame tool with a pin driver for driving pins into a frame element, comprising:
a housing;
a reciprocating driver blade moveable relative to said housing between a retracted position and an extended position;
a hammer arm assembly mounted in operational relationship to said guide shoe and configured to strike and bend the pin upon reaching said driven position; and
said driver blade is configured to be pivotally associated with said hammer arm assembly such that the movement of said driver blade from said retracted position to said extended position causes said hammer arm assembly to move from a first position to a second position at which the pin is bent.

17. The pin driver of claim 16 further including a guide shoe attached to said housing and associated with said driver blade for guiding the pin from a ready position to a driven position.

18. The pin driver of claim 16 further including a cylinder configured to drive said driver blade from said retracted position to said extended position.

19. The pin driver of claim 18 further including a driver blade seal configured to prevent air from escaping from said housing past said cylinder.

20. The pin driver of claim 19 further including a seal spacer provided for supporting said driver blade seal.

21. The pin driver of claim 17 wherein said guide shoe defines a pin driving axis and is configured to position said pin driving axis at an angle less than 90 degrees from a surface of the element.

22. A pin driver usable with a frame tool for driving pins into a frame element, comprising:
a reciprocating driver blade moveable between a retracted position and an extended position;
a guide shoe associated with said driver blade for guiding the pin from a ready position to a driven position;
a hammer arm assembly mounted in operational relationship to said guide shoe and configured to strike and bend the pin upon reaching said driven position;
said driver blade is configured to be pivotally associated with said hammer arm assembly such that the movement of said driver blade from said retracted position to said extended position causes said hammer arm assembly to move from a first position to a second position at which the pin is bent; and
said guide shoe is tapered towards a tip and said hammer arm assembly is configured to correspond to said taper.
